(19) United States
(12) Patent Application Publication
(10) Pub. No.: US 2022/0046966 A1
(43) Pub. Date: Feb. 17, 2022

(54) UMAMI FLAVOR COMPOSITION

(71) Applicant: DSM IP ASSETS B.V., Heerlen (NL)

(72) Inventors: Bernadette Theresia MOREL, Echt (NL); Marco Alexander VAN DEN BERG, Echt (NL); Elaheh JAMALZADEH, Echt (NL)

(21) Appl. No.: 17/312,435

(22) PCT Filed: Dec. 13, 2019
(86) PCT No.: PCT/EP2019/085076

§ 371 Date: Jun. 10, 2021

(30) Foreign Application Priority Data
Dec. 13, 2018 (EP) 18212182.2

(51) Int. Cl. A23L 27/20; A23L 27/22

(52) U.S. Cl. CPC A23L 27/2024; A23L 27/22

(57) ABSTRACT

The present invention relates to a method for producing a flavour composition comprising free glutamate, said method comprises providing wheat gluten and contacting the wheat gluten with a protease, with an exopeptidase and with a glutaminase to produce the flavour composition comprising free glutamate.

### FIELD

The present invention relates to a method for producing a flavour composition comprising free glutamate. According to another aspect, the present invention relates to a flavour composition. Further, the present invention relates to the use of the flavour composition.

### BACKGROUND OF THE INVENTION

Umami Is a basic taste which is commonly used in all kind of food items, like soups, sauces, marinades and seasonings. Compositions comprising free glutamate known for their umami enhancing properties in certain types of food. Flavour composition rich in free glutamate are derived from microorganisms such as yeast. Glutamate is also known as a strong enhancer of umami flavour in combination with 5′-ribonucleotides.

Glutamate, or glutamic acid, is commonly used as food additive and flavour enhancer in the form of its sodium salt, i.e. monosodium glutamate (MSG). The inclusion of MSG in food products requires to label the food products with the E number E621.

Over the years consumers more and more desire clean label food, without E numbers. Preferably the consumers use food wherein only ingredients which are known to the consumer from their own cupboard are included. Simultaneously, consumers would not accept food items which have less flavour. Hence the food industry is challenged with the provision of clean label food items while providing al the flavour properties as before.

With regard to umami, there is a need in the art to provide umami flavour compositions which are derived from consumer recognizable ingredients. At the same time, the umami flavour composition needs to provide enough umami flavour to food or feed items so the consumer would not be confronted with less flavour. Also, the same umami flavour composition providing enough umami flavour, should not impart a specific off-flavour to the food or feed items. An example of a raw material used for production of umami flavour composition is mushroom. The disadvantage of mushroom based flavour compositions is that they provide mushroom notes to the food or feed product the flavour composition is added to.

In view of the above, one of the problems to be solved by the present invention, amongst other problems, is the provision of an umami flavour composition that meet the consumer requirements in clean label without impairing the flavouring properties.

### DETAILED DESCRIPTION OF THE INVENTION

The present invention relates to a method for producing a flavour composition comprising free glutamate, said method comprises providing wheat gluten and contacting the wheat gluten with a protease, with an exopeptidase and with a glutaminase to produce the flavour composition comprising free glutamate.

Alternatively, the present invention relates to a method for producing a flavour composition comprising free glutamate, said method comprises providing wheat gluten and contacting the wheat gluten with a protease and optionally subsequently with an exopeptidase to produce the flavour composition comprising free glutamate.

Surprisingly, the present inventors found that treatment of wheat gluten according to the invention provides an umami flavour composition that is comparable with umami flavour compositions based on yeast. Hence, in a preferred embodiment, the present flavour composition suitable to provide or to enhance an umami flavour in food or feed. Although wheat gluten are used in the present invention as starting material, the present flavour composition can be used in application without introducing wheat gluten flavour to food or feed. This is advantageous in that the flavour composition can be used in a large variety of food or feed applications where a wheat gluten flavour is not desired.

A flavour composition is defined herein as a composition which can be safely used in food or feed products for human or animal consumption which composition improves the flavour (aroma and taste) perception, flavour release and/or mouthfeel of a food composition, by modulation of the flavour (aroma and taste) perception, flavour release and/or mouthfeel of a food composition.

The present wheat gluten is preferably in a powdered form. For example, Vital wheat gluten from Roquette. Wheat gluten is usually prepared by hydrating wheat flour followed by removal of starch. The gluten is then dried and ground into a powder. Powdered gluten, or vital wheat gluten is substantially free from starch. Preferably, the present wheat gluten comprises an amount of glutamate within the range of 10 to 50% (wt) on dry matter of the wheat gluten. More preferably, the present wheat gluten comprises an amount of glutamate within the range or 20 to 40% (wt) on dry matter of the wheat gluten. Most preferably, the present wheat gluten comprises an amount of glutamate within the range or 25 to 35% (wt) on dry matter of the wheat gluten.

In a preferred embodiment, the present step of providing wheat gluten, comprises suspending or mixing wheat gluten in water to provide a suspension of wheat gluten. Preferably the suspension of wheat gluten has a dry matter content within the range of 1 to 30% dry matter, preferably within the range of 2 to 15% dry matter, more preferably within the range of 3 to 10% dry matter. Preferably the present wheat gluten or the suspension of wheat gluten is heated. Heating can be carried out at a temperature within the range of 50° C. to 100° C., such as 60° C. to 98° C., 70° C. to 96° C. or 80° C. to 95° C. Preferably the heating is carried out for a time period within the range of 5 to 50 minutes, preferably 10 to 30 minutes, more preferably 15 to 25 minutes. The result of heating the wheat gluten is that the efficiency or the subsequent enzymatic treatment is increased. Furthermore, enzymes originally present in the wheat gluten, if any, are inactivated which reduces undesired effects. Alternatively, heating can comprise heating at 95° C. to 115° C. for a time period of 1 to 10 minutes, preferably in a continuous process.

A protease as used in the present context is defined as a hydrolase acting on peptide bonds. An endoprotease acts on peptide bonds in an endo-fashion, i.e. cleaving the peptide bonds anywhere in the polypeptide chain in contrast to a (exo)peptidase which is defined herein as a hydrolase acting on peptide bonds in a protein substrate in an exo fashion, i.e. acting near the ends of the polypeptide chain. The endoproteases are divided into subclasses on the basis of their catalytic mechanism: serine endoproteases (EC 3.4.21.xx), cysteine endoproteases (EC 3.4.22.xx), aspartic endoproteases (EC 3.4.23.xx) and metallo-endoproteases (EC 3.4.24.xx). Preferably, the present endoprotease has EC number 3.4.21.62.

In a preferred embodiment, the protease in the step of contacting the wheat gluten with a protease is an endoprotease. More preferably an endoprotease derived from Bacillus licheniformis. More preferably the endoprotease is a serine endoprotease, preferably a serine endoprotease that comprises subtilisin A or consists of subtilisin A. An example is Alcalase®. The advantage of using the endoprotease is that proteins in the wheat gluten are efficiently hydrolysed. Preferably, the present endoprotease has an enzyme activity of 605 Du/g.

In a preferred embodiment, the step of contacting the wheat gluten with a protease, or with a protease, exopeptidase and glutaminase is carried out at a pH within the range of 4 to 10 and/or a temperature within the range of 50° C. to 70° C. More preferably the pH is within the range of 6 to 9, more preferably within the range of 7.5 to 8.5, such as at pH 8. More preferably the temperature is within the range of 55° C. to 65° C. The time of the contacting step can be varied depending on the amount of protease used, which is routine for the skilled person to determine. Preferably, the time of the contacting step is within the range of 0.5 to 24 hours. More preferably within the range of 1 to 5 hours.

Preferably, the amount of protease during the step of contacting the wheat gluten with a protease is within the range or 0.1 to 10% (wt) on dry matter or the wheat gluten. More preferably the amount of protease during the step of contacting the wheat gluten with a protease is within the range or 0.5 to 5% (wt) on dry matter of the wheat gluten.

In a preferred embodiment, the pH of the wheat gluten or wheat gluten suspension after the step of contacting the wheat gluten with a protease is adjusted to a pH lower than 7, preferably lower than 6.5 or lower than 6. For example, the pH is controlled at a pH within the range of 3 to 7, 4 to 6, or more preferably pH 5 to pH 5.5.

In a preferred embodiment, the present method comprises contacting the wheat gluten with the protease and subsequently with the exopeptidase to produce the flavour composition comprising free glutamate.

In a further preferred embodiment, the present method comprises contacting the wheat gluten with the protease and subsequently with the exopeptidase and the glutaminase to produce the flavour composition comprising free glutamate.

In a more preferred embodiment, the present step of contacting the wheat gluten with the exopeptidase and the glutaminase is a single step. Preferably a single step wherein these enzymes are contacting the wheat gluten at the same time. Hence, the present contacting the wheat gluten with the exopeptidase and the glutaminase is preferably carried out simultaneously. Therefore, the exopeptidase and the glutaminase can be added together or separately, as long as these (active) enzymes are contacting the wheat gluten at overlapping times. Surprisingly, the present inventors found that a simultaneous contacting step of exopeptidase and the glutaminase increases the amount of free glutamate in comparison with the amount of free glutamate after adding first the exopeptidase and thereafter the glutaminase.

In a preferred embodiment, after contacting the wheat gluten with the protease, the wheat gluten is contacted with the exopeptidase, the proline-specific endoprotease and/or the glutaminase. The result of contacting the wheat gluten with the exopeptidase, the proline-specific endoprotease and/or the glutaminase is that the amount of free glutamate is enhanced. It is surprising that treatment of wheat gluten with the exopeptidase, the proline-specific endoprotease and/or the glutaminase results in the release of glutamate because it was expected that the accessibility of the wheat protein is too limited, or inhibitors are present in wheat, or that the exopeptidase is not specific on glutamate release and/or that pyroglutamate is produced.

In a preferred embodiment, the step of contacting the wheat gluten with the exopeptidase, the proline-specific endoprotease and/or the glutaminase is carried out at a pH within the range of 3 to 7 and/or a temperature within the range of 50° C. to 70° C. More preferably, the pH is within the range of 4 to 6, more preferably 5 to 5.5. More preferably, the temperature is within the range of 50° C. to 60° C. The time of the contacting step can be varied depending on the amount of exopeptidase used, which is routine for the skilled person. Preferably, the time of the contacting step is within the range of 0.5 to 24 hours. More preferably within the range of 1 to 5 hours.

Preferably, the amount of exopeptidase is within the range of 0.1 to 5% (wt) on dry matter of the flavour composition. More preferably, the amount of exopeptidase is within the range of 0.5 to 3% (wt) on dry matter of the flavour composition.

Preferably, the exopeptidase is derived from Aspergillus oryzae. More preferably, the exopeptidase is an enzyme mixture comprising endoprotease, preferably derived from Aspergillus oryzae. An example of such an enzyme mixture is Flavourzyme®. Preferably, the enzyme activity of the present enzyme mixture is 1255 U/g. Preferably, the exopeptidase has EC number 3.4.11.1.

In a further preferred embodiment, the present wheat gluten and/or the present flavour composition comprising free glutamate is further contacted with a proline-specific endoprotease. A proline-specific endoprotease is defined herein as an endoprotease cleaving protein or oligopeptides substrates at the C-terminal side of a proline residue in the protein or oligopeptides substrate. The proline-specific endoprotease has been classified as EC 3.4.21.26. The enzyme can be obtained from various sources such as mammalian sources, bacteria (e.f. Flavobacterium) and fungi (Aspergillus, in particular Aspergillus niger). The enzyme of Aspergillus niger has been described in detail in WO02/45524, WO02/46381, WO03/104382. A suitable fungal enzyme from Penicillium chrysogenum is disclosed in WO2009/144269. A suitable bacterial enzyme from Flavobacterium meningosepticum is disclosed in WO03068170. The advantage of using a proline-specific endoprotease is that it reduces any potential bitterness of the present flavour composition comprising free glutamate.

Contacting the present wheat gluten and or the present flavour composition comprising free glutamate with the proline-specific endoprotease can be performed together with contacting the wheat gluten with the exopeptidase in a single step. Contacting of the present wheat gluten and/or the present flavour composition comprising free glutamate with the proline-specific endoprotease can be performed in parallel or simultaneously or after or before contacting with the exopeptidase.

In a more preferred embodiment, the present step of contacting the wheat gluten with the exopeptidase, the proline-specific endoprotease and the glutaminase is a single step. Preferably a single step wherein these enzymes are contacting the wheat gluten at the same time. Hence, the present contacting the wheat gluten with the exopeptidase, the proline-specific endoprotease and the glutaminase is preferably carried out simultaneously. Therefore, the exopeptidase, the proline-specific endoprotease and the glutaminase can be added together or separately, as long as these (active) enzymes are contacting the wheat gluten at overlapping times. Surprisingly, the present inventors found that a simultaneous contacting step of exopeptidase, the proline-specific endoprotease and the glutaminase increases the amount of free glutamate in comparison with the amount of free glutamate after adding first the exopeptidase and the proline-specific endoprotease and thereafter the glutaminase.

Preferably, the amount of proline-specific endoprotease is within the range of 0.1 to 5% (wt) on dry matter of the flavour composition. More preferably, the amount of proline-specific endoprotease is within the range of 0.5 to 3% (wt) on dry matter of the flavour composition. Preferably, the time of the contacting step is within the range of 0.5 to 24 hours. More preferably within the range or 1 to 5 hours.

Preferably, after contacting the wheat gluten with protease, exopeptidase and/or proline-specific endoprotease and/or glutaminase, the flavour composition comprising free glutamate is heat treated to inactivate the protease, exopeptidase and/or proline-specific endoprotease. Preferably, heat treatment can be carried out at a temperature within the range of 50° C. to 100° C., such as 60° C. to 98° C., 70° C. to 96° C. or 80° C. to 95° C. Preferably the heating is carried out for a time period within the range of 5 to 50 minutes, preferably 10 to 30 minutes, more preferably 15 to 25 minutes. Alternatively, heating can comprise heating at 95° C. to 115° C. for a time period of 1 to 5 minutes, preferably in a continuous process.

In a preferred embodiment, the present protease is not inactivated, or not heat inactivated after contacting the wheat gluten with the protease. Hence, it is preferred that the present step of contacting the wheat gluten with the expeptidase, the proline-specific endoprotease and the glutaminase follows the step of contacting the wheat gluten with the protease without inactivating, preferably without heat inactivating, the present protease.

In a preferred embodiment, the present method comprises a step of contacting the flavour composition comprising free glutamate, or the wheat gluten, with a glutaminase (EC 3.5.1.2). The advantage of using a glutaminase is that it further increases the amount of free glutamate due to conversion of free glutamine into glutamate. Glutaminase (EC 3.5.1.2) is an amidohydrolase enzyme. The amount of glutaminase is preferably within the range of 0.01% to 10% (wt) of the flavour composition. More preferably, the amount of glutaminase is within the range of 0.1% to 5% (wt) of the flavour composition. Preferably, the temperature is within the range of 30° C. to 70° C. more preferably within the range of 40° C. to 60° C., such as 45° C. to 55° C. Preferably, the pH is within the range of 4 to 9, more preferably pH in the range of 5 to 8, such as within the range of 5.5 to 7. Preferably, step of contacting the flavour composition comprising free glutamate with a glutaminase is carried out for a time period within the range of 0.5 to 24 hours, more preferably within the range of 5 to 20 hours. The activity of the glutaminase is preferably 111 U/g.

Preferably, the present process comprises a heating step to inactivate glutaminase. Preferably, heat treatment can be carried out at a temperature within the range of 50° C. to 100° C., such as 60° C. to 98° C., 70° C. to 96° C. or 80° C. to 95° C. Preferably the heating is carried out for a time period within the range of 5 to 50 minutes, preferably 10 to 30 minutes, more preferably 15 to 25 minutes. Alternatively, heating can comprise heating at 95° C. to 115° C. for a time period of 1 to 5 minutes, preferably in a continuous process.

In another embodiment, the present method comprises a step of removing insoluble dry matter from the flavour composition. Preferably the present method comprises a centrifugation step wherein insoluble dry matter is separated from the flavour composition. This separation step results in a flavour composition having a low turbidity and/or high clarity. This is advantageous for certain applications where an additional colour in the food or feed product the flavour composition is added to is undesired.

In a preferred embodiment, the flavour composition comprising free glutamate is concentrated to a dry matter content of more than 20%, preferably more than 25%, more preferably more than 35% or even more than 40%, or even more than 60% Concentration can be carried out with an evaporator, such as with a failing film evaporator or a falling film plate evaporator.

In another preferred embodiment, the present method further comprises formulating the flavour composition with a carrier selected from salt, maltodextrin, yeast extract, starch, highly branched amylopectin, cellulose and gum Arabic, and/or spray drying the flavour composition to a dry matter content of at least 95%.

In a preferred embodiment, the present flavour composition comprising free glutamate is contacted with active carbon or activated charcoal.

In a further preferred embodiment, the present flavour composition comprising free glutamate comprises an amount of free glutamate or more than 0.1% (wt) on carrier free dry matter of the flavour composition. Preferably more than 0.2% (wt), more than 0.3% (wt), more than 0.4% (wt), 0.5% (wt), more than 2% (wt), more than 4% (wt), more than 6% (wt), more than 8% (wt) or more than 10% (wt) of free glutamate on carrier free dry matter of the flavour composition. More preferably, the present flavour composition comprises an amount of glutamate within the range of 0.1 to 25% (wt) on carrier free dry matter of the flavour composition. More preferably, the present flavour composition comprises an amount of (free) glutamate within the range of 5 to 20% (wt) on carrier free dry matter of the flavour composition, such as 6 to 15% (wt) on carrier free dry matter of the flavour composition, or 8 to 12% (wt) on carrier free dry matter of the flavour composition, or 9 to 11% (wt) on carrier free dry matter of the flavour composition.

In a preferred embodiment, the present flavour composition comprises a percentage of free glutamate of total free amino acids that is within the range of 1 to 50%, more preferably within the range of 10 to 40%, even more preferably 15 to 30%, most preferably within the range of 20 to 30%. The advantage of the specified amount of free glutamate is that the flavour composition delivers an umami flavour impact that is comparable with the umami flavour impact of yeast based flavour compositions.

Given the beneficial umami flavour, the present invention relates, according to another aspect, to a flavour composition comprising an amount of free glutamate of more than 0.1% (wt) or more than 6% (wt) on carrier free dry matter of the flavour composition.

In a preferred embodiment, the present amount free glutamate is more than 7% (wt), more than 8% (wt), more than 9% (wt) or more than 10% (wt). More preferably, the present amount of free glutamate is within the range of 5 to 15% (wt), more preferably within the range of 8 to 13% (wt).

Alternatively, the present invention relates to a flavour composition, comprising free glutamate and pyroglutamate, wherein the amount of pyroglutamate to free glutamate is less than 10% (wt), preferably less than 5% (wt), more preferably less than 4% (wt), even more preferably less than, 3% (wt) or 2% (wt). The amount of pyroglutamate to free glutamate can be calculated as the percentage of pyroglutamate amount to free glutamate amount.

Preferably, the present flavour composition comprises an amount of free glutamate of more than 6% (wt) on carrier free dry matter of the flavour composition and comprising pyroglutamate, wherein the amount of pyroglutamate to free glutamate is less than 10% (wt), preferably less than 5% (wt), more preferably less than 4% (wt), even more preferably less than, 3% (wt) or 2% (wt).

In a preferred embodiment the present flavour composition comprises a ratio of pyroglutamate to free glutamate that is below 13%, more preferably below 12%, even more preferably below 11%, even more preferably below 10%, even more preferably below 9%, even more preferably below 8%, even more preferably below 7%, even more preferably below 6%, even more preferably below 5%, even more preferably below 4%, even more preferably below 3%, even more preferably below 2%, even more preferably below 1%. Most preferably the present flavour composition comprises a ratio of pyroglutamate to free glutamate that is 0%. In a preferred embodiment the present flavour composition comprises glycerol between 0.1% and 5% (w/w), more preferably between 0.1% and 4% (w/w), even more preferably between 0.1% and 3% (w/w), even preferably between 0.1% and 2% (w/w) on dry matter. Most preferably the present flavour composition glycerol between 0.1% and 1% (w/w) on dry matter.

Carrier free dry matter is defined as the dry matter of the flavour composition excluding a carrier. Carriers, known as drying aids, are generally used to make a process economically and technically viable and these additives should have a foodstuff status and contribute to increase the glass transition temperature of the mixture. Examples of such carriers are salt, maltodextrin, yeast extract, starch, highly branched amylopectin, cellulose and gum Arabic.

The present flavour composition has preferably an amount of total amino acids within the range of 50 to 95% (wt) of the flavour composition. More preferably an amount of total amino acids within the range of 70 to 90% (wt) of the flavour composition. Even more preferably an amount of total amino acids within the range of 75 to 85% (wt) of the flavour composition.

In a further preferred embodiment, the present flavour composition comprises glycerol. Preferably an amount of glycerol within the range of 1 to 5% (wt) on dry matter. The advantage of including glycerol is enhanced drying properties.

Preferably, the flavour composition is in spray dried form. In spray dried form, the flavour composition is stable for at least 12 months during storage at room temperature.

In a preferred embodiment the present flavour composition comprises NaCl. More preferably the present flavour composition comprises NaCl in the concentration of 1% 40% (w/w), more preferably 5%-40% (w/w), even more preferably 5%-20% (w/w) or even more preferably 1%-10% (w/w).

In a preferred embodiment the present flavour composition comprises maltodextrin. More preferably the present flavour composition comprises maltodextrin in the concentration of 1%-50% (w/w), more preferably 5%-40% (w/w), even more preferably 5%-20% (w/w).

In a preferred embodiment, the present flavour composition is suitable to provide or to enhance an umami flavour or umami taste in food or feed. More preferably, the present flavour composition is suitable to provide or to enhance an umami flavour or umami taste in food or reed if dosed in an amount of 0.01 to 0.5% (wt) on salt free dry matter of the food or reed. Even more preferably, the present flavour composition is suitable to provide or to enhance an umami flavour or umami taste in food or feed if dosed in an amount of 0.05 to 0.3% (wt), or 0.1 to 0.2% (wt), on salt free dry matter of the food or feed. Hence, the present composition is able to provide an umami flavour while it is dosed in small amounts. A further advantage of the present flavour composition is that it does not provide a wheat gluten flavour to the food or feed. Preferably the food or feed item is bouillon, such as vegetable bouillon.

In a preferred embodiment, the present flavour composition comprises an anti-oxidant, for example vitamin C or vitamin E. The advantage of adding an anti-oxidant is to prevent oxidation of the flavour composition.

Preferably, the flavour composition is obtainable by a method according to the present invention.

In a preferred embodiment, the present flavour composition is packed in a bag of at least 1 kg, preferably at least 2 kg, preferably at least 3 kg, preferably at least 4 kg, preferably at least 5 kg, preferably at least 6 kg, preferably at least 7 kg, preferably at least 8 kg, preferably at least 9 kg, preferably at least 10 kg. More preferably the flavour composition is packed in a bag of 15 to 30 kg, such as a bag of 20 to 25 kg.

In another aspect, the present invention relates to food or feed comprising the present flavour composition. Preferably, the food or feed comprises the present flavour composition in an amount of 0.01 to 0.5% (wt) on salt free dry matter of the food or feed. Preferably the food or feed comprises the present flavour composition in an amount of 0.05 to 0.3% (wt), or 0.1 to 0.2% (wt), on salt free dry matter of the food or feed.

In a further aspect, the present invention relates to the use of the flavour composition for providing an umami taste in food or in feed. More preferably, the present invention relates to the use for enhancing an umami taste in food or In feed. Preferably, the present flavour composition provides or enhances an umami taste without introducing a wheat gluten flavour to the food or feed.

Given the umami flavour enhancing properties of the present invention, the invention also relates to the use of the present umami flavour as a replacer of yeast extract or yeast autolysate. The Food Chemical Codex defines a yeast extract” as follows: “Yeast Extract comprises the water soluble components of the yeast cell, the composition of which is primarily amino-acids, peptides, carbohydrates and salts. Yeast Extract is produced through the hydrolysis of peptide bonds by the naturally occurring enzymes present in edible yeast or by the addition of food-grade enzymes' The Food Chemical Codex defines Autolysed Yeast as follows: “Autolysed Yeast is the concentrated, not extracted, partially soluble digest obtained from food-grade yeasts. Solubilisation is accomplished by enzyme hydrolysis or autolysis of yeast cells. Autolysed Yeast contains both soluble and Insoluble components derived from the whole yeast cell”.

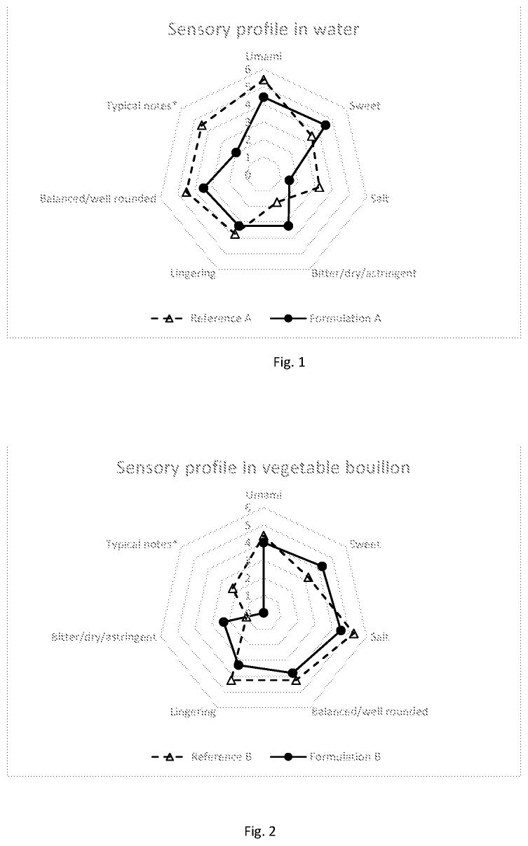

The invention is further illustrated in the examples below, wherein reference is made to the figures. FIGS. 1 and 2 show the mean intensity scores of attributes relevant for the present invention.

### EXAMPLES

### Example 1

Production of an Umami Flavour Composition from Wheat Gluten

Wheat gluten products can be used to produce an umami flavour composition. A wheat gluten slurry with a dry matter content of 7.5% was prepared. The suspension was heated for 20 min at 95° C. The slurry was incubated at a concentration of 3.0% (v/w) on dm for 3 h at 50° C. with Alcalase (Novozymes, Bogsvaerd, Denmark, endoprotease). The pH was controlled at pH 8. At the end of this incubation the pH of the wheat gluten slurry was adjusted to 5.3.

To obtain a product with increased free glutamate levels, the wheat gluten slurry was incubated by Flavourzyme (Novozymes, Bogsvaerd, Denmark, endoprotease and exopeptidase) at a dose of 3 wt % on dm and a proline-specific endoprotease (as disclosed in WO02/45524) at a dose of 3 wt %. on dm The wheat gluten slurry was incubated during 3 hours at 55° C. to produce product A. After these incubations obtaining Product A, the enzymes were heat inactivated.

To obtain a product with increased free glutamate levels, Product A was further incubated by Glutaminase (Amano Enzyme Inc., Nagoya, Japan) at a dose of 1 wt % dm to convert the free glutamine into free glutamate. The wheat gluten slurry was incubated during 16 hours at 80° C. at pH 6.0 to produce product B. After this incubation obtaining Product B, the enzymes were heat inactivated.

After these incubations obtaining Product A and Product B, the products were concentrated as such to produce Product A and B by falling film evaporator to a concentrate with a dry matter content of 35-65% dm. These Products A and B were formulated with carriers and spray dried. The composition of the provided umami flavour composition Product A and Product B are shown in table 1.

TABLE 1
content umami flavour composition

| | Product A | Product B |
|---|---|---|
| | % on carrier | % on carrier free |
| Component | free dry matter | dry matter |
| Free glutamate | 0.6 | 4.2 |
| Free amino acids | 16.3 | 16.2 |
| Total amino acids | 67.4 | 65.5 |

### Example 2

### Production of an Umami Flavour Composition from Wheat Gluten—Enzymes Combined—

Wheat gluten products can be used to produce an umami flavour composition. A wheat gluten slurry with a dry matter content of 7.5% was prepared. The suspension was heated for 20 min at 95° C. The slurry was incubated with Alcalase (Novozymes, Bogsvaerd, Denmark, endoprotease) at a concentration of 3.0 wt % on dm for 3 h at 80° C. The pH was controlled at pH 6. At the end of this incubation the pH of the wheat gluten suspension was adjusted to 5.3.

To obtain a product with increased free glutamate levels, the wheat gluten slurry was incubated with the following enzymes simultaneously: (1) Flavourzyme (Novozymes, Bogsvaerd, Denmark, endoprotease and exopeptidase) at a dose of 3 wt % dm and (2) a proline-specific endoprotease (as disclosed in WO2/45524) at a dose of 3 wt % and (3) Glutaminase (Amano Enzyme Inc., Nagoya, Japan) at a dose of 1 wt % dm to convert the released free glutamine into free glutamate. The wheat gluten slurry was incubated during 16 hours at 55° C. After these incubations obtaining Product C, the enzymes were heat inactivated.

After these incubations obtaining Product C, the product was concentrated as such to produce Product C by falling film evaporator to a concentrate with a dry matter content of 35-65% dm. The Product C was formulated with carriers and spray dried. The composition of the provided umami flavour composition Product C was compared to Product A and Product B shown in table 2.

TABLE 2
content umami flavour composition

| | Product A | Product B | Product C |
|---|---|---|---|
| | (example 1) | (example 1) | (example 2) |
| | % on carrier free | % on carrier free | % on carrier free |
| Component | dry matter | dry matter | dry matter |
| Free glutamine | 4.1 | 0.1 | ND |
| Free glutamate | 0.6 | 4.2 | 12.4 |
| Pyroglutamate | NA | 1.1 | ND |
| Free amino acids | 16.3 | 16.2 | 33.6 |
| Total amino acids | 67.4 | 65.5 | 67.5 |

NA = Not Analysed
ND = Not detected (Free glutamine <0.01%; Pyroglutamate <0.4%)

### Example 3

### Evaluation on the Umami Effect of Umami Flavour Compositions in Water

The wheat gluten product was processed according to the method as described in example 1, leading to Product A and Product B. To show the effect of the two applied processes, the characteristic sensorial profile of the umami flavour composition Product A and B at 0.6 wt % SFDM (salt free dry matter) was compared in water in the presence of 0.4 wt % sal (NaCl). For the umami score, Product A and Product B were compared to 0.05 wt % MSG. Evaluation was performed with savoury experts (n=4). The results, are listed in Table 3.

TABLE 3
Descriptors of the flavor compositions and umarni intensity in water

| | Umami intensity | Description |
|---|---|---|
| MSG | 100 | |
| Product A | 35 | Sweet, wheat, caramel, very light umami, |
| | | very light bitter note |
| Product B | 80 | Umami, Sweet, caramel, wheat like, bitter. |

### Example 4

### Sensory Profile of the Umami Flavour Composition in Water

The wheat gluten product was processed according to the method as described in Example 1, leading to Product B. To show the effect of the applied processing, the characteristic sensorial profile of the umami flavour composition Product B was compared to the yeast extract Gistex Standard (DSM, the Netherlands) in water. The application formulations which were used, are listed in Table 4.

TABLE 4
Compositions of water for
lotions; all numbers in weight (g)

| Ingredients | Formulation A | Reference A |
|---|---|---|
| Salt (NaCl) | 2.00 | 0.00 |
| Gistex Standard | 0.00 | 5.00 |
| Product B | 3.00 | 0.00 |
| Water | 1000 | 1000 |

Both products, Product B and Gistex Standard, were tested at 0.3% SFDM (salt free dry matter) in water and offered at a temperature of around 60° C. The formulation A and reference A, were tested in a bind test by an expert panel for savoury applications (n=6).

For the profiling a pre-defined set of 6 attributes was used (umami, sweet, salt, dry/astringent, lingering, balanced/well rounded). Besides the pre-defined set attributes, the panelists could also describe their own attributes to indicate whether they noticed typical notes for each product, and score on this. Panelists had to score the attributes from 0 (not present) to 5 (very strong present).

FIG. 1 shows the mean intensity scores of the attributes in Formulation A and Reference A. The sensory profiles in water of Gistex Standard (Reference A) and Product B (Formulation A) at the same SFDM, were a little different. Formulation A is somewhat more sweet and dry, less salty and has lower typical notes, but on lingering balancing effect comparable to Reference A. The typical notes of the Reference A, were described as meaty and sulphury and the typical notes of Formulation A were described as very slightly papery, but almost neutral.

### Example 5

### Sensory Profile of the Umami Flavour Composition in Vegetable Bouillon

The wheat gluten product was processed according the method as described in Example 1, leading to product B. To show the effect of the applied processing, the characteristic sensorial profile of the Umami flavour composition Product B was compared to the yeast extract Gistex Standard (DSM, the Netherlands) in vegetable bouillon. The application formulations which were used, are listed in Table 4. Vegetable bouillon Formulation B contained Product B from Example 1 and Vegetable bouillon Reference B was produced with the Reference product Gistex Standard. Both products, Product B from Example 1 and Gistex Standard, were implemented at 0.09% SFDM in the vegetable bouillon.

TABLE 5
Compositions of vegetable bouillon formulations;
all numbers in weight (g).

| Ingredients | Formulation B | Reference B |
|---|---|---|
| Maltodextrin | 9.90 | 9.90 |
| Salt (NaCl) | 6.20 | 5.60 |
| Gistex Standard | 0.00 | 1.50 |
| Fat powder | 1.46 | 1.46 |
| Product B | 0.90 | 0.00 |
| Onion powder | 0.56 | 0.56 |
| Carrot juice powder | 0.47 | 0.47 |
| Turmeric powder | 0.30 | 0.30 |
| Nutmeg | 0.06 | 0.06 |
| Parsley leaves | 0.05 | 0.05 |
| Black pepper | 0.03 | 0.03 |
| Rosemary ground | 0.03 | 0.03 |
| Lovage | 0.02 | 0.02 |
| Thyme ground | 0.02 | 0.02 |
| Water | 1000 | 1000 |

The vegetable bouillons, Formulation B and Reference B, were prepared by dry blending of all ingredients from Table 5, after which it was mixed with tap water of 95° C. and stirred until homogeneity. The vegetable bouillions, Formulation B and Reference B, were cooled down until 60° C. before sensorial evaluation. The samples were tested in a blind test by an expert panel for savoury applications (n=6).

For the profiling a pre-defined set of 6 attributes was used (umami, sweet, sal, dry/astringent, lingering, balanced/well rounded). Besides the pro-defined set, the panelists could also define their own attributes to indicate whether they noticed some typical notes for each variable, and score on this. Panelists had to score the attributes from 0 (not present) to 5 (very strong present).

FIG. 2 shows the mean intensity scores of the attributes in Formulation B and Reference B. The profiles of Formulation B and Reference B are quite similar. Formulation B containing Product B from Example 1, was somewhat more sweet, dry and less typical note, but on the other attributes it was quite comparable to Reference B. The typical notes of Reference B containing Gistex Standard, were described as meaty and sulphury. There were no typical notes described for Formulation B.

### Example 6

### Umami Impact of the Umami Flavour Composition in Water

The wheat gluten product was processed according to the method as described in Example 1, leading to Product B. To show the effect of the applied processing, the umami impact of the umami flavour composition Product B was compared to the yeast extract Gistex Standard (DSM, the Netherlands) in water. The application formulations which were used, are listed in Table 6.

Both products, Product B and Gistex Standard, were tested at 0.3% SFDM (salt free dry matter) in water and offered at a temperature of around 60° C. The samples, Formulation A and Reference A, were tested in a blind test by an expert panel for savoury applications (n=7).

TABLE 6
Compositions of formulation in water; all numbers in weight (g).

| Ingredients | Formulation A | Reference A |
|---|---|---|
| Salt (NaCl) | 2.00 | 0.00 |
| Gistex Standard | 0.00 | 5.00 |
| Product B | 3.00 | 0.00 |
| Water | 1000 | 1000 |

Each panellist received a set of two coded samples (Formulation A and Reference A) and was asked to indicate which of the two samples was highest on umami taste. Approximately 50% of the panellists scored the Reference A as most umami and the other 50% of the panellists scored Formulation A (containing Product B) as highest on umami. This indicated that for Formulation A and Reference A, there was little difference between the umami impact. Therefore, Product B of the present invention provides umami flavour.

TABLE 7
Ranking of the umami strength in a blind panel test
(2 = highest umami, 1 = lowest umami).

| | Panelist | | | | | | |
|---|---|---|---|---|---|---|---|
| Ingredients | p. 1 | p. 2 | p. 3 | p. 4 | p. 5 | p. 6 | p. 7 |
| Formulation A | 2 | 2 | 1 | 1 | 2 | 1 | 2 |
| Reference A | 1 | 1 | 2 | 2 | 1 | 2 | 1 |

### Example 7

### Umami Impact of the Umami Flavour Composition in Vegetable Bouillon

The wheat gluten product was processed according to the method as described in Example 1, leading to Product B. To show the effect of the applied processing, the characteristic umami impact of the umami flavour composition (Product B) was compared to the yeast extract Gistex Standard (DSM, the Netherlands) in vegetable bouillon.

Both products, Product B and Gistex Standard, were tested at 0.09% SFDM in vegetable bouillon. This vegetable bouillons Formulation B and Reference B were prepared by dry blending all ingredients from Table 8, after which it was mixed with tap water of 95° C. and stirred until homogeneity. The vegetable bouillons were cooled down until 30° C. before sensorial evaluation. The vegetable bouillons Formulation B and Reference B were tested in a blind test by an expert panel for savoury applications (n=7).

TABLE 8
Compositions of vegetable bouillon formulations;
all numbers in weight (g).

| Ingredients | Formulation B | Reference B |
|---|---|---|
| Maltodextrin | 9.90 | 9.90 |
| Salt (NaCl) | 6.20 | 5.60 |
| Gistex Standard | 0.00 | 1.50 |
| Fat powder | 1.46 | 1.46 |
| Product B | 0.90 | 0.00 |
| Onion powder | 0.56 | 0.56 |
| Carrot juice powder | 0.47 | 0.47 |
| Turmeric powder | 0.30 | 0.30 |
| Nutmeg | 0.06 | 0.06 |
| Parsley leaves | 0.05 | 0.05 |
| Black pepper | 0.03 | 0.03 |
| Rosemary ground | 0.03 | 0.03 |
| Lovage | 0.02 | 0.02 |
| Thyme ground | 0.02 | 0.02 |
| Water | 1000 | 1000 |

Each panelist received a set of two coded samples (Formulation B and Reference B) and was asked to Indicate which of the two samples was highest on umami taste. Approximately 50% of the panelists scored Reference B as most umami and the other 50% of the panelists scored Formulation B (containing Product B) as highest on umami. This Indicated that there was little difference between the umami Impact of Formulation B and Reference B.

TABLE 9
Ranking of the umami strength in a blind panel test
(2 = highest umami, 1 = lowest umami).

| | Panelist | | | | | | |
|---|---|---|---|---|---|---|---|
| Ingredients | p. 1 | p. 2 | p. 3 | p. 4 | p. 5 | p. 6 | p. 7 |
| Formulation B | 2 | 2 | 1 | 1 | 2 | 1 | 1 |
| Reference B | 1 | 1 | 2 | 2 | 1 | 2 | 2 |

### Example 8

### Umami Impact of the Umami Flavour Composition in Water

The wheat gluten product was processed according to the method as described in example 1 and 2, leading to Product B and Product C. To show the effect of the two applied processes, the umami impact of the umami flavour composition Product B and C at 0.5 wt % was compared in water in the presence of 0.3 wt % sak (NaCl) or in the presence of 0.3 wt % salt (NaCl)+0.013% (wt) nucleotides IMP and GMP, 0.0065% (wt) each. A ranking test has been done and the panelists received the two products at once, and their task was to order the products from low to high perceived umami flavor. The samples, formulation B and formulation C, were tested in a blind test by a trained panel (n=11). For both tests formulation C showed the highest umami Impact.

TABLE 10
Results of blind panel test
(nr. of persons which scored sample highest on umami)

| | Concentration | Sensory score | Sensory score (0.4% |
|---|---|---|---|
| | (%) | (0.4% | NaCl + 0.013% IG |
| Ingredients | in water | NaCl solution) | solution) |
| Product B | 0.5 | 2 | 0 |
| Product C | 0.5 | 9 | 11 |

### Example 9

### Umami Impact of the Umami Flavour Composition in Beef Bouillon

The wheat gluten products were processed according the method as described in Example 1 and 2, leading to product B and product C. To show the effect of the applied processing, the umami impact of the umami flavour composition Product B was compared to Reference B in beef bouillon, and umami flavour composition Product C was compared to Reference C in beef bouillon. The application formulations which were used, are listed in Table 11.

Both products, Product B and Product C, were tested at 0.2% in beef bouillon. The beef bouillons Formulation B, Reference B, Formulation C and Reference C were prepared by dry blending all Ingredients from Table 11, after which it was mixed with tap water of 95° C. and stirred until homogeneity. The beef bouillons were cooled down until 80° C. before sensorial evaluation. The beef bouillons were tested in a bind test by an expert panel for savoury applications (n=8).

TABLE 11
Compositions of beef bouillon formulations;
all numbers in weight (g)

| | Formulation | Reference | Formulation | Reference |
|---|---|---|---|---|
| | B | B | C | C |
| Water | 980 | 980 | 980 | 980 |
| maltodextrin | 7.05 | 5.25 | 7.05 | 5.25 |
| salt | 6.82 | 6.62 | 6.82 | 6.62 |
| powder fat | 2.80 | 2.80 | 2.80 | 2.80 |
| Product B | 0.00 | 2.00 | 0.00 | 0.00 |
| Product C | 0.00 | 0.00 | 0.00 | 2.00 |
| modified starch | 1.70 | 1.70 | 1.70 | 1.70 |
| beef extract | 0.80 | 0.80 | 0.80 | 0.80 |
| caramel powder | 0.40 | 0.40 | 0.40 | 0.40 |
| garlic powder | 0.18 | 0.18 | 0.18 | 0.18 |
| onion powder | 0.10 | 0.10 | 0.10 | 0.10 |
| white pepper | 0.06 | 0.06 | 0.06 | 0.06 |
| citric acid | 0.04 | 0.04 | 0.04 | 0.04 |
| tumeric powder | 0.03 | 0.03 | 0.03 | 0.03 |
| nutmeg | 0.02 | 0.02 | 0.02 | 0.02 |
| | 1000 | 1000 | 1000 | 1000 |

Each panelist received a 2 set of two coded samples (set 1: Formulation B and Reference B and set 2: Formulation C and Reference C) and was asked to Indicate which of the two samples was highest on umami taste.

For the first set, approximately 60% of the panelists scored formulation B as most umami. For the second set, approximately 90% of the panelists scored formulation C as most umami.

TABLE 12
Results of blind panel test
(nr. of persons which scored sample highest on umami )

| Ingredients | Sensory score |
|---|---|
| Reference B | 3 |
| Formulation B | 5 |
| Reference C | 1 |
| Formulation C | 7 |

### Example 10

### Umami Impact of the Umami Flavour Composition in Cheese Sauce

The wheat gluten product was processed according to the method as described in Example 2, leading to Product C. To show the effect of the applied processing, the characteristic sensorial profile of the umami flavour composition Product C was compared to Reference C in cheese sauce. The application formulations which were used, are listed in Table 13.

TABLE 13
Compositions of cheese sauce formulation; all numbers in weight (g)

| | Formulation C | Reference C |
|---|---|---|
| water | 830 | 830 |
| Cheese powder | 42.50 | 42.50 |
| Modified starch | 44.20 | 44.20 |
| Whey powder | 20.40 | 20.40 |
| Maltodextrin | 20.29 | 21.91 |
| Skimmed milk powder | 13.60 | 13.60 |
| Cream powder | 10.20 | 10.20 |
| Fat powder | 10.20 | 10.20 |
| Salt | 6.20 | 6.38 |
| Product C | 2.00 | 0.00 |
| Lactic acid | 0.26 | 0.26 |
| White pepper | 0.26 | 0.26 |
| Nutmeg | 0.09 | 0.09 |
| | 1000 | 1000 |

Evaluation was performed with experts (n=4). The results, are listed in Table 14.

TABLE 14
Descriptors of flavor composition C in cheese sauce

| Ingredients | Description |
|---|---|
| Reference C | Mild cheese flavor, |
| Formulation C | More enhanced the overall flavor profile, longer |
| | lasting and rounded. Increased the authentic cheese |
| | taste, more creamy. Balanced acidity and saltiness |

1. A method for producing a flavor composition comprising free glutamate, said method comprising providing wheat gluten and contacting the wheat gluten with a protease, with an exopeptidase and with a glutaminase to produce the flavor composition comprising free glutamate.

2. The method according to claim 1, comprising contacting the wheat gluten with the protease and subsequently with the exopeptidase to produce the flavor composition comprising free glutamate.

3. The method according to claim 1, comprising contacting the wheat gluten with the protease and subsequently with the exopeptidase and the glutaminase to produce the flavor composition comprising free glutamate.

4. The method according to claim 1, further comprising contacting the wheat gluten with a proline-specific endoprotease.

5. The method according to claim 4, wherein contacting the wheat gluten with the exopeptidase, the proline-specific endoprotease and the glutaminase is a single step.

6. The method according to claim 1, wherein the contacting the wheat gluten with the exopeptidase, the proline-specific endoprotease and/or the glutaminase to produce the flavor composition comprising free glutamate is carried out at a pH within L range of 3 to 7 and/or a temperature within a range of 50° C. to 70° C.

7. The method according to claim 1, wherein the flavor composition comprising free glutamate comprises an amount of free glutamate of more than 0.1% (wt) on carrier free dry matter of the flavor composition.

8. A flavor composition comprising an amount of free glutamate of more than 6% (wt) on carrier free dry matter of the flavor composition.

9. The flavor composition according to claim 8, comprising an amount of pyroglutamate of less than 0.1% (wt) on carrier free dry matter of the flavor composition.

10. The flavor composition comprising free glutamate and pyroglutamate, wherein the amount of pyroglutamate to free glutamate of less than 15% (wt), optionally less than 10% (wt), optionally less than 5% (wt).

11. A flavor composition comprising an amount of free glutamate of more than 6% (wt) on carrier free dry matter of the flavor composition. that is obtainable by a method according to claim 1.

12. The flavor composition according to claim 8, wherein the flavor composition is packed in a bag of at least 1 kg, optionally of at least 10 kg.

13. Food or feed comprising the flavor composition according to claim 8.

14. A product comprising the flavor composition according to claim 8, for providing an umami taste in food or in feed.

15. A product comprising the flavor composition according to claim 8, for enhancing an umami taste in food or in feed.
